(19) United States
(12) Patent Application Publication
(10) Pub. No.: US 2014/0122543 A1
(43) Pub. Date: May 1, 2014

(54) INFORMATION PROCESSING APPARATUS, METHOD, AND PROGRAM

(71) Applicant: Sony Corporation, Tokyo (JP)

(72) Inventors: Kenji Tanaka, Kanagawa (JP); Yoshihiro Takahashi, Kanagawa (JP); Kazumasa Tanaka, Kanagawa (JP); Michiro Hirai, Kanagawa (JP)

(73) Assignee: Sony Corporation, Tokyo (JP)

(21) Appl. No.: 14/057,522

(22) Filed: Oct. 18, 2013

(30) Foreign Application Priority Data
Oct. 25, 2012 (JP) 2012-235589

(51) Int. Cl. G06F 17/30

(52) U.S. Cl. CPC G06F 17/30091
USPC 707/823

(57) ABSTRACT

There is provided an information processing apparatus including a rearrangement unit configured to, when a plurality of files are recorded on a plurality of recording media, optimally rearrange the plurality of files arranged in the plurality of recording media by repeating selecting each file arranged in each recording medium and swapping each selected file after the plurality of files are arranged in the plurality of recording media, and a recording control unit configured to perform control in a manner that the plurality of files rearranged by the rearrangement unit are recorded on the plurality of recording media.

### CROSS REFERENCE TO RELATED APPLICATIONS

This application claims the benefit of Japanese Priority Patent Application JP 2012-235589 filed Oct. 25, 2012, the entire contents of which are incorporated herein by reference.

### BACKGROUND

The present disclosure relates to an information processing apparatus, a method for the same, and a program, and particularly relates to an information processing apparatus, a method for the same, and a program which are configured to minimize wasteful consumption of a recording medium.

A device is described in JP 2010-39805A, the device being configured to approximate a combination of a plurality of contents having fixed time lengths to the user's spare time and to successively distribute the combined contents set by this approximation. A method for transferring a plurality of different OS images is described in JP 2012-68790A describes.

Both JP 2010-39805A and JP 2012-68790A described above propose efficient data distribution to eliminate the spare time.

### SUMMARY

Meanwhile, in recent years there are storages which make it appear as if a plurality of discs were one volume. In such storages, a file is recorded in such a manner as to span a plurality of discs. In addition, if efforts are made to check disc spanning in recording the file, the disc is wastefully consumed.

Under these circumstances, it is desirable to minimize wasteful consumption of a recording medium.

According to an embodiment of the present disclosure, there is provided an information processing apparatus including a rearrangement unit configured to, when a plurality of files are recorded in a plurality of recording media, optimally rearrange the plurality of files arranged in the plurality of recording media by repeating selecting each file arranged in each recording medium and swapping each selected file after the plurality of files are arranged in the plurality of recording media, and a recording control unit configured to perform control in a manner that the plurality of files rearranged by the rearrangement unit are recorded in the plurality of recording media.

The rearrangement unit may adopt swapping each selected file when a size of a resultant unusable region in the plurality of recording media is reduced by selecting each file arranged in each recording medium and swapping each selected file.

The rearrangement unit may prohibit swapping each selected file when the size of the resultant unusable region in the plurality of recording media is not reduced by selecting each file arranged in each recording medium and swapping each selected file, or when all of the plurality of files are not arranged in the plurality of recording media.

The rearrangement unit may repeat selecting each file arranged in each recording medium and swapping each selected file until the size of the resultant unusable region in the plurality of recording media reaches a predetermined size or smaller.

The rearrangement unit may repeat selecting each file arranged in each recording medium and swapping each selected file until a number of repetition times reaches a predetermined number of times.

According to an embodiment of the present disclosure, there is provided an information processing method including optimally rearranging, by an information processing apparatus, when a plurality of files are recorded in a plurality of recording media, the plurality of files arranged in the plurality of recording media by repeating selecting each file arranged in each recording medium and swapping each selected file after the plurality of files are arranged in the plurality of recording media, and performing control, by the information processing apparatus, in a manner that the plurality of rearranged files are recorded in the plurality of recording media.

According to an embodiment of the present disclosure, there is provided a program for causing a computer to function as a rearrangement unit configured to, when a plurality of files are recorded in a plurality of recording media, optimally rearrange the plurality of files arranged in the plurality of recording media by repeating selecting each file arranged in each recording medium and swapping each selected file after the plurality of files are arranged in the plurality of recording media, and a recording control unit configured to perform control in a manner that the plurality of files rearranged by the rearrangement unit are recorded in the plurality of recording media.

In the one embodiment of the present disclosure, when the plurality of files are recorded in the plurality of recording media, the plurality of files are arranged in the plurality of recording media, and thereafter selecting and swapping the corresponding files arranged in the recording medium are repeated. Thereby, the plurality of files arranged in the plurality of recording media are optimally rearranged. Then, control is performed of recording the plurality of files thus rearranged in the plurality of recording media.

According to the embodiment of the present disclosure, it is possible to minimize wasteful consumption of a recording medium.

### BRIEF DESCRIPTION OF THE DRAWINGS

FIG. 1 is a diagram illustrating a configuration example of an information processing system to which an embodiment of the present technology is applied;

FIG. 2 is a block diagram illustrating a configuration example of an information processing apparatus;

FIG. 3 is a block diagram illustrating a functional configuration example of the information processing apparatus;

FIG. 4 is a diagram illustrating a case where disc spanning is not checked;

FIG. 5 is a diagram illustrating a case where disc spanning is checked;

FIG. 6 is a diagram illustrating an example of checking disc spanning in a case of recording a plurality of files;

FIG. 7 is a diagram illustrating another example of checking disc spanning in the case of recording a plurality of files;

FIG. 8 is a diagram illustrating optimization according to the embodiment of the present technology;

FIG. 9 is a flowchart for explaining processing of recording a plurality of files; and

FIG. 10 is a flowchart for explaining file rearrangement processing.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### [Configuration of Information Processing System According to Embodiment of Present Technology]

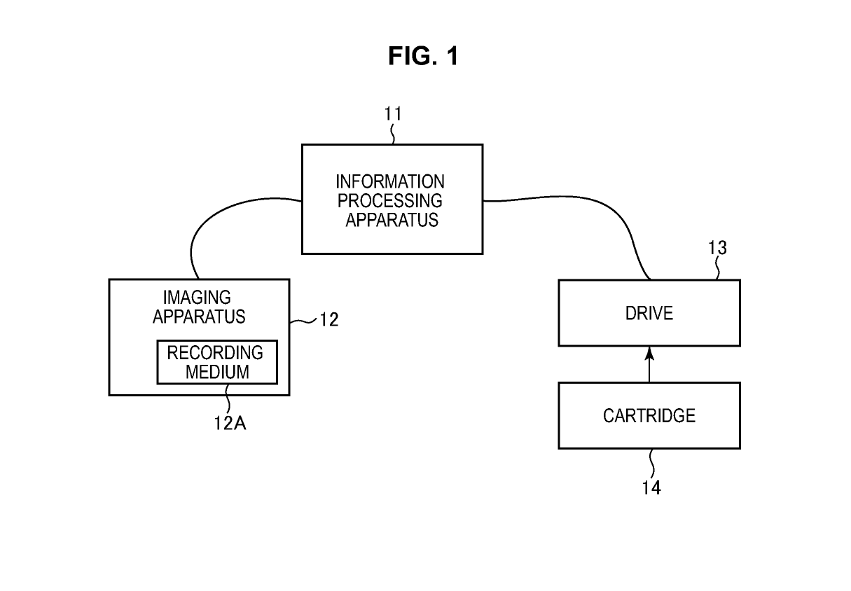

FIG. 1 is a diagram illustrating a configuration example of an information processing system to which an embodiment of the present technology is applied.

The information processing system in FIG. 1 includes an information processing apparatus 11, an imaging apparatus 12, a drive 13, and a cartridge 14.

The information processing apparatus 11 is configured of a personal computer, for example. The information processing apparatus 11 is connectable to the imaging apparatus 12 and the drive 13 through a USB 3.0, for example. When being connected to the imaging apparatus 12 and the drive 13, the information processing apparatus 11 writes one or more files stored in a recording medium 12A of the connected imaging apparatus 12 to the cartridge 14 loaded on the drive 13, in accordance with the user's manipulation.

The imaging apparatus 12 captures an image of a subject and records a file of a captured image (a moving image or a still image) in the recording medium 12A. The recording medium 12A is configured of an optical disc, a memory card, or the like.

The drive 13 includes the cartridge 14 attachably and detachably loaded thereon. Under control of the connected information processing apparatus 11, the drive 13 writes a file of the imaging apparatus 12 or the information processing apparatus 11 to a recording medium included in the cartridge 14 and erases the file.

The cartridge 14 is a data storage configured such that one volume includes 12 recording media. Note that the recording media are optical discs, for example. A description is given below of an example in which the cartridge 14 includes 12 optical discs. However, the recording media are not necessarily limited to the optical discs, and the number of the recording media is not limited to 12.

Note that the example in FIG. 1 shows that the file recorded in the recording medium 12A is written to the cartridge 14 loaded on the drive 13 while the imaging apparatus 12 is connected to the information processing apparatus 11. In contrast, for example, a file recorded in the recording medium 12A may be written to the cartridge 14 loaded on the drive 13 while the recording medium 12A is loaded on a drive for the recording medium 12A connected to the information processing apparatus 11 through a USB.

### [Configuration of Information Processing Apparatus]

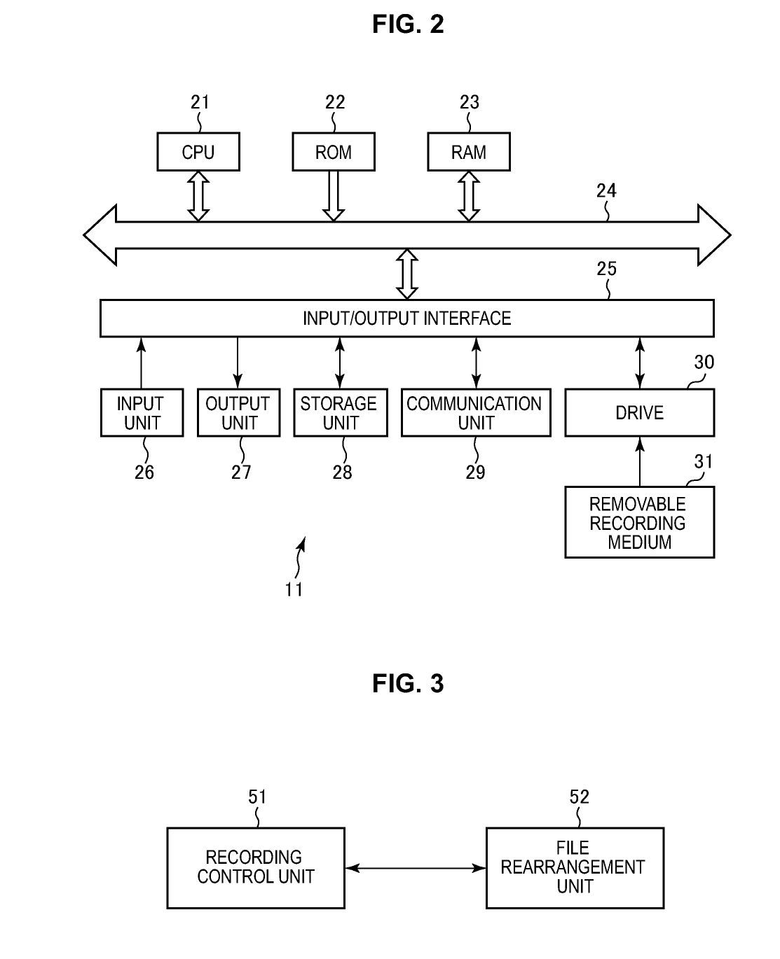

FIG. 2 is a diagram illustrating a configuration example of an information processing apparatus to which the embodiment of the present technology is applied.

In the information processing apparatus 11, a CPU (Central Processing Unit) 21, a ROM (Read Only Memory) 22, and a RAM (Random Access Memory) 23 are mutually connected through a bus 24.

An input/output interface 25 is connected to the bus 24 further. To the input/output interface 25, an input unit 26, an output unit 27, a storage unit 28, a communication unit 29, and a drive 30 are connected.

The input unit 26 is configured of a keyboard, a mouse, a microphone, and the like. The output unit 27 is configured of a display, a speaker, and the like. The storage unit 28 is configured of a hard disk, a non-volatile memory, or the like. The communication unit 29 is configured of a network interface or the like.

The drive 30 drives a removable recording medium 31 such as a magnetic disk, an optical disc, a magneto-optical disc, or a semiconductor memory to record data and delete data recorded in the removable recording medium 31.

In the information processing apparatus 11 as configured above, the CPU 21 loads a program stored, for example, in the storage unit 28 on the RAM 23 through the input/output interface 25 and the bus 24, and executes the program. Thereby, functional blocks, for example, in FIG. 3 are configured, and predetermined processing is performed.

Note that the hardware configuration of the information processing apparatus 11 is not limited to the example in FIG. 2 and may be configured at least to achieve a functional configuration in FIG. 3.

### [Functional Configuration Example of Information Processing Apparatus]

FIG. 3 is a block diagram illustrating a functional configuration example of the information processing apparatus. Note that an example in FIG. 3 shows a functional configuration example in the case where processing of recording a plurality of files in the cartridge 14 loaded on the drive 13 is performed.

In the example in FIG. 3, the information processing apparatus 11 includes a recording control unit 51 and a file rearrangement unit 52.

The recording control unit 51 receives an instruction for recording a plurality of files through the input unit 26 (information on which files should be recorded). For example, an instruction for recording eight files is inputted to the recording control unit 51 through the input unit 26. In this case, the recording control unit 51 checks for regions where no file is recorded in the optical discs and determines optical discs (for example, two optical discs) included in the cartridge 14 where the eight files should be recorded.

Then, the recording control unit 51 logically arranges the eight files in the two determined optical discs in the order in accordance with the instruction so that disc spanning of the files can be prevented, and causes the file rearrangement unit 52 to optimally rearrange the arranged files. The recording control unit 51 controls the drive 13 to record the eight files in the two optical discs in the order of the files rearranged by the file rearrangement unit 52.

The file rearrangement unit 52 repeats selecting one file from each of the two optical discs including the plurality of files arranged by the recording control unit 51 and swapping the files. In this way, the file rearrangement unit 52 optimally rearranges the plurality of files arranged in the plurality of recording media.

Specifically, the file rearrangement unit 52 selects one file from each of the two optical discs including the plurality of files arranged by the recording control unit 51 and swaps the files. In this way, the file rearrangement unit 52 calculates the size of a resultant unavailable region in each recording target optical disc. When the calculated size is smaller than the size of a resultant unavailable region before the rearrangement, the file rearrangement unit 52 adopts the swapping between the two files. When the calculated size is larger than the size of the resultant unavailable region before the rearrangement, the file rearrangement unit 52 prohibits the swapping between the two files. Alternatively, also when all of the plurality of files are not arranged in the plurality of optical discs, the swapping between the two files is prohibited. Hereinafter, a resultant unavailable region is also referred to as an unusable region.

Note that the file rearrangement unit 52 repeats the file swapping until the size of the unusable regions in the plurality of optical discs reaches a predetermined size or smaller or until the number of repetition times reaches a predetermined number of times or smaller.

### [Example of Disc Spanning in Related Art]

Since the cartridge 14 includes the plurality of optical discs, files to be written are arranged in such a manner as to span the plurality of optical discs when being stored therein (hereinafter, referred to as disc spanning) Note that the files are logically and sequentially written to a plurality of strip regions in the optical discs constituting the cartridge 14.

Occurrence of disc spanning might cause the speed of accessing a file to be extremely slow, thus causing various harmful effects. Hence, it is desirable to check disc spanning as much as possible.

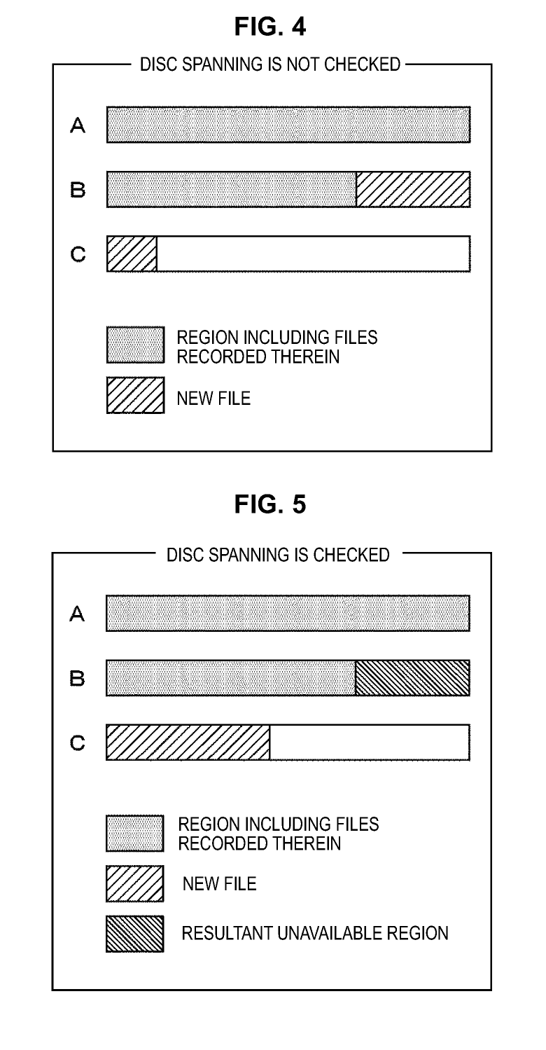

An example in FIG. 4 shows recording states of three optical discs A, B, and C in the case where disc spanning is not checked.

As illustrated in FIG. 4, a new file is recorded in a region following a region extending halfway through the optical disc B from the optical disc A and including files recorded therein. For this reason, the new file is arranged in such a manner as to span the optical disc B and the optical disc C.

An example in FIG. 5 shows recording states of the three optical discs A to C in the case where disc spanning is checked. When it is known in advance that a new file is too large to be recorded in a remaining region of the optical disc B in checking disc spanning, the optical disc for the recording is changed from one to another, and the new file is recorded from the top of the next optical disc C, as illustrated in FIG. 5. At this time, the optical disc B has a resultant unavailable region (the remaining region of the optical disc B).

As in the example in FIG. 5, substantial reduction of a disc region due to the resultant unavailable region is a side effect of the checking of disc spanning However, when a plurality of files are recorded, it is possible to minimize the reduction by changing the recording order.

### [Disc Spanning Example in Case of Recording Plurality of Files]

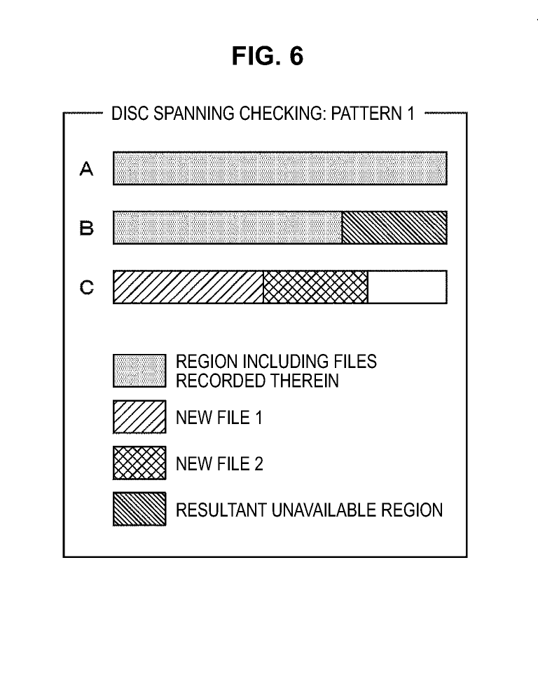

FIG. 6 shows recording states of the three optical discs A to C in the case where disc spanning is checked.

It is known in advance that a new file 1 to be recorded first is too large to be recorded in a remaining region of the optical disc B, the remaining region following the region extending halfway through the optical disc B from the optical disc A and including files recorded therein. In this case, the optical disc for the recording is changed from one to another, and recording of the new file 1 and a new file 2 is performed in order from the top of the next optical disc C. At this time, the optical disc B has a resultant unavailable region (unusable region). In other words, the remaining region of the optical disc B is the resultant unavailable region.

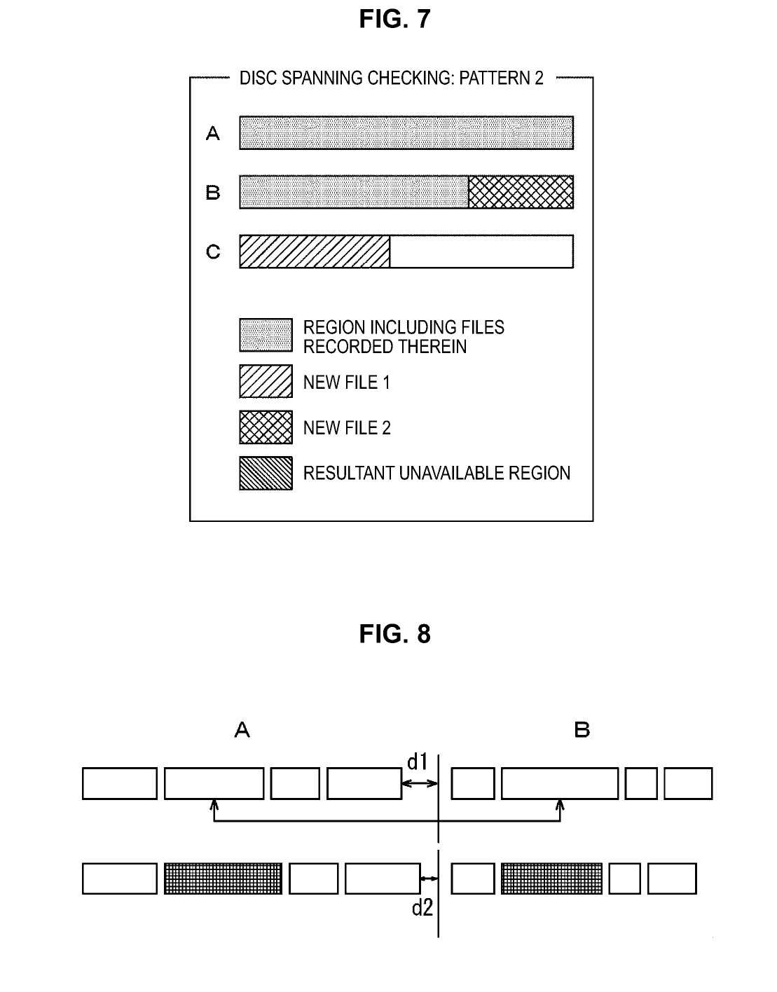

FIG. 7 shows recording states of the three optical discs A to C in the case where disc spanning is checked.

It is known in advance that the new file 2 can be recorded in the remaining region of the optical disc B, the remaining region following the region extending halfway through the optical disc B from the optical disc A and including files recorded therein. In this case, a resultant unavailable region is reduced by changing arrangement (recording order) of the new files 1 and 2.

As described above, it is possible to make a resultant unavailable region smaller by appropriately changing the order at the time of recording (file arrangement).

This is generalized as optimization processing in which when there is a need to record a plurality of files in optical discs, it is judged which recording order is used to make it possible to minimize (or make very small) a resultant unavailable region. When disc spanning of optical discs is actually checked, it is necessary to perform the optimization processing in a limited time period to determine the file recording order.

For example, suppose optimization processing performed in the following manner. When there is a need to store 100 files in two optical discs in a spanning manner, a resultant unavailable region is made small in the first optical disc to store the files while minimizing gaps. To perform the processing, there are 2̂100 (=1.27×10̂30) ways of arranging the files including the case where all of the files are not stored in the optical discs. It is not practical to evaluate all of the ways based on direct calculations.

Hence, the embodiment of the present technology uses a method for performing optimization processing at very high speed by calculating a smaller number of combinations.

### [Description of Optimization Processing According to Present Technology]

With reference to FIG. 8, a description is given of optimization processing according to an embodiment of the present technology in the case where disc spanning is checked.

Firstly, the recording control unit 51 sequentially records a plurality of files (eight files in this case) in the two optical discs A and B in the order in accordance with the instruction as illustrated in an upper part of FIG. 8. Note that recording is not performed actually, but the files are logically arranged.

Next, the file rearrangement unit 52 randomly selects one of the files from each of the optical discs A and B as illustrated by the arrow in the upper part of FIG. 8, and swaps the files as illustrated in a lower part of FIG. 8. Note that when the swapping does not cause resultant unavailable region reduction or cause file overflow in any of the optical discs, the swapping is prohibited.

The file rearrangement unit 52 repeats the swapping processing: until the size of a resultant unavailable region reaches a predetermined size or smaller; or a predetermined number or processing times.

In this way, for example, a resultant unavailable region d2 after the rearrangement is made smaller than a resultant unavailable region d1 before the rearrangement.

Note that the predetermined size is set at, for example, approximately 1/10,000 of the total size of the optical discs. For example, for optical discs in 100G bytes, approximately 10M bytes is set. Thereby, the size of the resultant unavailable regions of the discs attributable to the checking of disc spanning is limited to 1/10,000 or smaller of the total size of the optical discs.

### [Operation of Information Processing Apparatus]

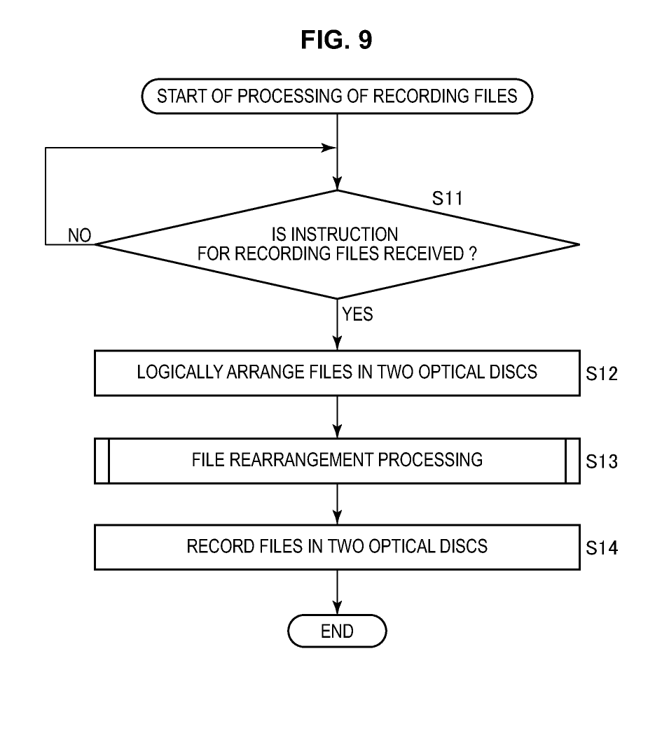

Next, processing of recording a plurality of files performed by the information processing apparatus 11 will be described with reference to a flowchart in FIG. 9. Note that an example in FIG. 9 shows the case where a plurality of files are recorded in two optical discs constituting the cartridge 14.

In Step S11, the recording control unit 51 waits until it is judged that an instruction for recording the plurality of files is received.

For example, by manipulating the mouse or the like included in the input unit 26, the user instructs for writing the plurality of files stored in the recording medium 12A of the imaging apparatus 12 to the cartridge 14 loaded on the drive 13.

Upon receipt of the user's instruction through the input unit 26, the recording control unit 51 judges in Step S11 that the instruction for recording the plurality of files is received, and proceeds to Step S12.

For example, an instruction for recording eight files is inputted to the recording control unit 51 through the input unit 26. The recording control unit 51 checks for regions where no file is recorded in the optical discs and determines the number of optical discs (for example, 2) where the eight files can be recorded.

In Step S12, the recording control unit 51 logically and sequentially arranges the plurality of files (the eight files in the case of FIG. 8) in the two optical discs.

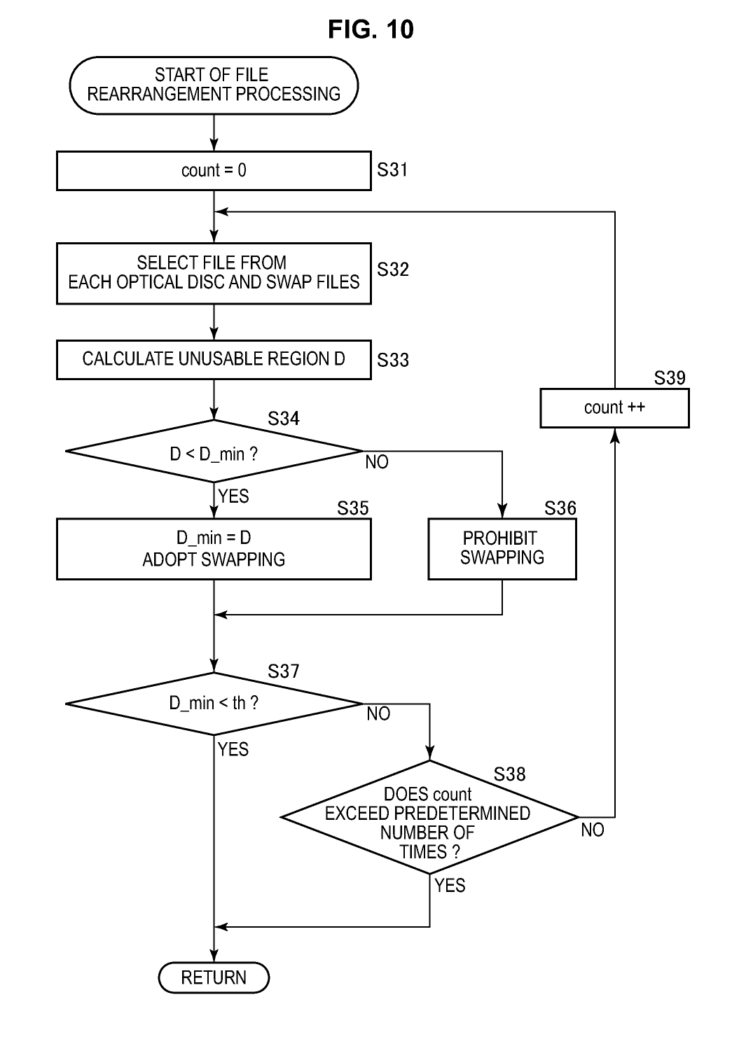

In Step S13, the file rearrangement unit 52 performs processing of rearranging the files arranged by the recording control unit 51. The file rearrangement processing will be described later with reference to FIG. 10. In Step S13, the plurality of files arranged in the two optical discs are optimally rearranged.

In Step S14, the recording control unit 51 controls the drive 13 to cause the plurality of files rearranged in Step S13 to be recorded in the two optical discs constituting the cartridge 14.

Next, the file rearrangement processing in Step S13 in FIG. 9 will be described with reference to a flowchart in FIG. 10.

In Step S31, the file rearrangement unit 52 sets 0 as count. In Step S32, the file rearrangement unit 52 selects one of the plurality of files sequentially arranged from each of the two optical discs and swaps the files.

In Step S33, the file rearrangement unit 52 calculates an unusable region D which is to result from the file rearrangement.

In Step S34, the file rearrangement unit 52 judges whether or not the unusable region D calculated in Step S33 is smaller than a smallest unusable region D_min. Note that in the first judgment, the smallest unusable region D_min is an unusable region in the optical discs where the files are logically arranged in Step S12 in FIG. 9.

If it is judged in Step S34 that the unusable region D is smaller than the smallest unusable region D_min, the processing proceeds to Step S35. In Step S35, the file rearrangement unit 52 sets D_min =D and adopts the swapping.

If it is judged in Step S34 that the unusable region D is not smaller than the smallest unusable region D_min, the processing proceeds to Step S36. In Step S36, the file rearrangement unit 52 prohibits the swapping. In other words, the files swapped in Step S32 are arranged in the original locations.

In Step S37, the file rearrangement unit 52 judges whether or not D_min is smaller than a predetermined size th. If it is judged in Step S37 that D_min is smaller than the predetermined size th, the rearrangement processing is terminated. The processing moves back to Step S13 in FIG. 9.

If it is judged in Step S37 that D_min is not smaller than the predetermined size th, the processing proceeds to Step S38. In Step S38, it is judged whether or not count exceeds a predetermined number of times. If it is judged in Step S38 that count exceeds the predetermined number of times, the file rearrangement processing is terminated. The processing moves back to Step S13 in FIG. 9.

If it is judged in Step S38 that count does not exceed the predetermined number of times, the processing proceeds to Step S39. In Step S39, the file rearrangement unit 52 increments count by 1. Thereafter, the processing moves back to Step S32, and the subsequent steps are repeated.

As described above, the plurality of files arranged in the plurality of optical discs are optimally rearranged. Thus, it is possible to minimize wasteful consumption of the optical discs based on a practical time calculation amount, while checking disc spanning.

Note that the description has been given of the example of recording the plurality of files in the plurality of optical discs in the cartridge configured such that one volume includes the plurality of recording media, but the embodiment of the present technology is not limited to the cartridge configured such that one volume includes the plurality of recording media. In other words, the embodiment of the present technology is applicable to a case of recording a plurality of files just in a plurality of recording media.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

In this case, as one example, the program executed by the computer (the CPU 21) in FIG. 2 may be provided by being recorded on the removable recording medium 31 as a packaged medium or the like. The program can also be provided via a wired or wireless transfer medium, such as a local area network, the Internet, or a digital satellite broadcast.

In the computer, by loading the removable recording medium 31 into the drive 30, the program can be installed into the storage unit 28 via the input/output interface 25. It is also possible to receive the program from a wired or wireless transfer medium using the communication unit 29 and install the program into the storage unit 28. As another alternative, the program can be installed in advance into the ROM 22 or the storage unit 28.

It should be noted that the program executed by a computer may be a program that is processed in time series according to the sequence described in this specification or a program that is processed in parallel or at necessary timing such as upon calling.

In the present disclosure, steps of describing the above series of processes may include processing performed in time-series according to the description order and processing not processed in time-series but performed in parallel or individually.

The embodiment of the present disclosure is not limited to the above-described embodiment. It should be understood by those skilled in the art that various modifications, combinations, sub-combinations and alterations may occur depending on design requirements and other factors insofar as they are within the scope of the appended claims or the equivalents thereof.

For example, the present technology can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Further, an element described as a single device (or processing unit) above may be divided and configured as a plurality of devices (or processing units). On the contrary, elements described as a plurality of devices (or processing units) above may be configured collectively as a single device (or processing unit). Further, an element other than those described above may be added to each device (or processing unit). Furthermore, a part of an element of a given device (or processing unit) may be included in an element of another device (or another processing unit) as long as the configuration or operation of the system as a whole is substantially the same. In other words, an embodiment of the disclosure is not limited to the embodiments described above, and various changes and modifications may be made without departing from the scope of the disclosure.

It should be understood by those skilled in the art that various modifications, combinations, sub-combinations and alterations may occur depending on design requirements and other factors insofar as they are within the scope of the appended claims or the equivalents thereof.

The present technology may also be configured as below.

(1) An information processing apparatus including:

a rearrangement unit configured to, when a plurality of files are recorded in a plurality of recording media, optimally rearrange the plurality of files arranged in the plurality of recording media by repeating selecting each file arranged in each recording medium and swapping each selected file after the plurality of files are arranged in the plurality of recording media; and

a recording control unit configured to perform control in a manner that the plurality of files rearranged by the rearrangement unit are recorded in the plurality of recording media.

(2) The information processing apparatus according to (1), wherein the rearrangement unit adopts swapping each selected file when a size of a resultant unusable region in the plurality of recording media is reduced by selecting each file arranged in each recording medium and swapping each selected file.
(3) The information processing apparatus according to (1) or (2), wherein the rearrangement unit prohibits swapping each selected file when the size of the resultant unusable region in the plurality of recording media is not reduced by selecting each file arranged in each recording medium and swapping each selected file, or when all of the plurality of files are not arranged in the plurality of recording media.
(4) The information processing apparatus according to any one of (1) to (3), wherein the rearrangement unit repeats selecting each file arranged in each recording medium and swapping each selected file until the size of the resultant unusable region in the plurality of recording media reaches a predetermined size or smaller.
(5) The information processing apparatus according to any one of (1) to (3), wherein the rearrangement unit repeats selecting each file arranged in each recording medium and swapping each selected file until a number of repetition times reaches a predetermined number of times.
(6) An information processing method including:

optimally rearranging, by an information processing apparatus, when a plurality of files are recorded in a plurality of recording media, the plurality of files arranged in the plurality of recording media by repeating selecting each file arranged in each recording medium and swapping each selected file after the plurality of files are arranged in the plurality of recording media; and

performing control, by the information processing apparatus, in a manner that the plurality of rearranged files are recorded in the plurality of recording media.

(7) A program for causing a computer to function as:

a rearrangement unit configured to, when a plurality of files are recorded in a plurality of recording media, optimally rearrange the plurality of files arranged in the plurality of recording media by repeating selecting each file arranged in each recording medium and swapping each selected file after the plurality of files are arranged in the plurality of recording media; and

a recording control unit configured to perform control in a manner that the plurality of files rearranged by the rearrangement unit are recorded in the plurality of recording media.

What is claimed is:

1. An information processing apparatus comprising:
a rearrangement unit configured to, when a plurality of files are recorded in a plurality of recording media, optimally rearrange the plurality of files arranged in the plurality of recording media by repeating selecting each file arranged in each recording medium and swapping each selected file after the plurality of files are arranged in the plurality of recording media; and
a recording control unit configured to perform control in a manner that the plurality of files rearranged by the rearrangement unit are recorded in the plurality of recording media.

2. The information processing apparatus according to claim 1, wherein the rearrangement unit adopts swapping each selected file when a size of a resultant unusable region in the plurality of recording media is reduced by selecting each file arranged in each recording medium and swapping each selected file.

3. The information processing apparatus according to claim 2, wherein the rearrangement unit prohibits swapping each selected file when the size of the resultant unusable region in the plurality of recording media is not reduced by selecting each file arranged in each recording medium and swapping each selected file, or when all of the plurality of files are not arranged in the plurality of recording media.

4. The information processing apparatus according to claim 3, wherein the rearrangement unit repeats selecting each file arranged in each recording medium and swapping each selected file until the size of the resultant unusable region in the plurality of recording media reaches a predetermined size or smaller.

5. The information processing apparatus according to claim 3, wherein the rearrangement unit repeats selecting each file arranged in each recording medium and swapping each selected file until a number of repetition times reaches a predetermined number of times.

6. An information processing method comprising:
optimally rearranging, by an information processing apparatus, when a plurality of files are recorded in a plurality of recording media, the plurality of files arranged in the plurality of recording media by repeating selecting each file arranged in each recording medium and swapping each selected file after the plurality of files are arranged in the plurality of recording media; and
performing control, by the information processing apparatus, in a manner that the plurality of rearranged files are recorded in the plurality of recording media.

7. A program for causing a computer to function as:
a rearrangement unit configured to, when a plurality of files are recorded in a plurality of recording media, optimally rearrange the plurality of files arranged in the plurality of recording media by repeating selecting each file arranged in each recording medium and swapping each selected file after the plurality of files are arranged in the plurality of recording media; and
a recording control unit configured to perform control in a manner that the plurality of files rearranged by the rearrangement unit are recorded in the plurality of recording media.
